(19) United States
(12) Patent Application Publication
(10) Pub. No.: US 2010/0153996 A1
(43) Pub. Date: Jun. 17, 2010

(54) GESTURE BASED ELECTRONIC PROGRAM MANAGEMENT SYSTEM

(76) Inventors: Charles J. Migos, San Francisco, CA (US); Nadav M. Neufeld, Sunnyvale, CA (US); Gionata Mettifogo, Menlo Park, CA (US); Afshan A. Kleinhanzl, San Francisco, CA (US)

Correspondence Address: VIERRA MAGEN/MICROSOFT CORPORATION, 575 MARKET STREET, SUITE 2500, SAN FRANCISCO, CA, 94105, US

(21) Appl. No.: 12/337,445

(22) Filed: Dec. 17, 2008

(51) Int. Cl. G06F 13/00

(52) U.S. Cl. 725/39

(57) ABSTRACT

A computing system includes a display surface that displays an electronic program guide. A sensor is used to sense the presence of an object adjacent to the display surface. Based on the data from the sensor about the object adjacent to the display surface interacting with the electronic program guide, the system determines which gesture of a set of possible gestures the object is performing. For example, the system may determine that a hand is sliding across the display surface or rotating an icon on the display surface. The system will perform a function related to the electronic program guide based on the determined gesture.

### BACKGROUND

Users have access to an ever increasing amount and variety of content. For example, a user may have access to hundreds of television channels via cable television, satellite, digital subscriber line (DSL), and so on. Traditionally, users “surf” through the channels via channel-up or channel-down buttons on a remote control to determine what is currently being broadcast on each of the channels.

As the number of channels grew, electronic program guides (EPGs) were developed such that the users could determine what was being broadcast on a particular channel without tuning to that channel. For purposes of this document, an EPG is an on-screen guide to content, typically with functions allowing a viewer to navigate and select content. There are many different types of EPGs and no one type of format is required.

As the number of channels continue to grow, the techniques employed by traditional EPGS to manually scroll through this information has become inefficient and frustrating.

### SUMMARY

An electronic program guide (or other content management system) is provided that is operated based on gestures. The electronic program guide is displayed on a display surface of a computing system. A sensor is used to sense the presence and/or movements of an object (e.g., a hand) adjacent to the display surface. Based on the data from the sensor about the object adjacent to the display surface and interacting with the electronic program guide, the computing system determines which gesture of a set of possible gestures the object is performing. Once the gesture is identified, the computer system will identify a function associated with that gesture and the computing system will perform that function for the electronic program guide.

One embodiment includes displaying the electronic program guide on a first portion of a display surface, automatically sensing an item adjacent to the first portion of the display surface, automatically determining that a first type of gesture of a plurality of types of gestures is being performed by the item adjacent to the surface, automatically identifying a function associated with the first type of gesture, and performing the function. The function includes manipulating the electronic program guide on the first portion of the display.

One example implementation includes one or more processors, one or more storage devices in communication with the one or more processors, a display surface in communication with the one or more processors, and a sensor in communication with the one or more processors. The one or more processors cause an electronic program guide to be displayed on the display surface. The sensor senses presence of an object adjacent to the display surface. Based on data received from the sensor, the one or more processors are programmed to determine which gesture of a plurality of types of gestures is being performed by the object on the surface in an interaction with the electronic program guide. The one or more processors perform a function in response to the determined gesture.

One example implementation includes one or more processors, one or more storage devices in communication with the one or more processors, a display surface in communication with the one or more processors, and a sensor in communication with the one or more processors. The one or more processors cause an image associated with a content item to be displayed on the display surface. The sensor senses data indicating moving of an object adjacent the display surface in the general direction from a position of the image on the display surface toward a content presentation system. The data is communicated from the sensor to the one or more processors. The one or more processors send a message to a content presentation system (e.g., television, stereo, etc.) to play the content item.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of one embodiment of a computing system with an interactive display device.

FIG. 2 is a cut-away side view of a computing system with an interactive display device.

FIG. 3 depicts an example of a computing system with an interactive display device.

FIGS. 4A-4D depict a portion of a display surface and the data detected by a sensor.

FIG. 5 depicts an example of a computing system with an interactive display device in communication with a television system,

FIG. 6 depicts an EPG displayed on a display surface.

FIG. 7 is a flow chart describing one embodiment of a process for obtaining EPG data.

FIG. 8 is a flow chart describing one embodiment of a process for providing an EPG that responds to gestures.

FIG. 9 is a flow chart describing one embodiment of a process for scrolling an EPG using a gesture.

FIG. 10 is a flow chart describing one embodiment of a process for tagging programs in an EPG using gestures.

FIG. 11 is a flow chart describing one embodiment of a process for reporting which programs have been tagged using gestures.

FIG. 12 is a flow chart describing one embodiment of a process for searching using an EPG with gestures.

FIG. 13 is a flow chart describing one embodiment of a process for searching using an EPG with gestures.

FIG. 14 is a flow chart describing one embodiment of a process for adding programs to lists using gestures.

FIG. 15 is a flow chart describing one embodiment of a process for reviewing recommended programs using gestures.

FIG. 16 is a flow chart describing one embodiment of a process for configuring an EPG to control other devices using gestures.

FIG. 17 depicts an EPG displayed on a display surface.

FIG. 18 is a flow chart describing one embodiment of a process for using an EPG to control other devices using gestures.

FIG. 19 is a flow chart describing one embodiment of a process performed by a television system in response to commands from an EPG.

FIG. 20 depicts an EPG displayed on a display surface.

FIG. 21 is a flow chart describing one embodiment of a process for changing the display size of an item in an EPG using a gesture.

FIG. 22 is a flow chart describing one embodiment of a process for controlling the play of a video in an EPG using gestures.

FIG. 23 is a flow chart describing one embodiment of a process for changing the display size of an item in an EPG using a gesture.

### DETAILED DESCRIPTION

An electronic program guide is provided that is operated based on gestures. The electronic program guide is displayed on a display surface of a computing system. A sensor is used to sense the presence and/or movements of an object (e.g., a hand or other body part) adjacent to the display surface. Based on the data from the sensor about the object (e.g. hand) adjacent to the display surface and interacting with the electronic program guide, the computing system determines which gesture of a set of possible gestures the object is performing. Once the gesture is identified, the computer system will identify a function associated with that gesture and the computing system will perform that function for the electronic program guide.

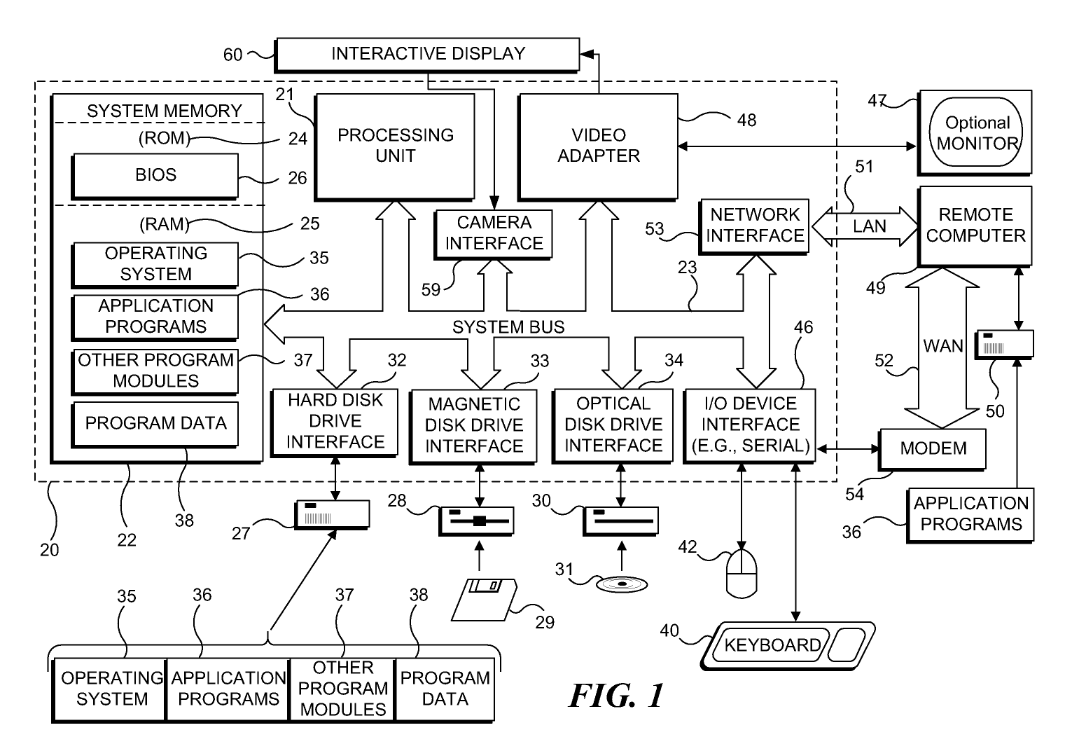

FIG. 1 depicts one example of a suitable computing system 20 with an interactive display 60 for implementing the electronic program guide that is operated based on gestures. Computing system 20 includes a processing unit 21, a system memory 22, and a system bus 23. The system bus couples various system components including the system memory to processing unit 21 and may be any of several types of bus structures, including a memory bus or memory controller, a peripheral bus, and a local bus using any of a variety of bus architectures. Processing unit 21 includes one or more processors. The system memory includes read only memory (ROM) 24 and random access memory (RAM) 25. A basic input/output system (BIOS) 26, containing the basic routines that help to transfer information between elements within the Computing system 20, such as during start up, is stored in ROM 24. Computing system 20 further includes a hard disk drive 27 for reading from and writing to a hard disk (not shown), a magnetic disk drive 28 for reading from or writing to a removable magnetic disk 29, and an optical disk drive 30 for reading from or writing to a removable optical disk 31, such as a compact disk-read only memory (CD-ROM) or other optical media. Hard disk drive 27, magnetic disk drive 28, and optical disk drive 30 are connected to system bus 23 by a hard disk drive interface 32, a magnetic disk drive interface 33, and an optical disk drive interface 34, respectively. The drives and their associated computer readable media provide nonvolatile storage of computer readable machine instructions, data structures, program modules, and other data for computing system 20. Although the exemplary environment described herein employs a hard disk, removable magnetic disk 29, and removable optical disk 31, it will be appreciated by those skilled in the art that other types of computer readable media, which can store data and machine instructions that are accessible by a computer, such as magnetic cassettes, flash memory cards, digital video disks (DVDs), Bernoulli cartridges, RAMs, ROMs, and the like, may also be used in the exemplary operating environment.

A number of program modules may be stored on the hard disk, magnetic disk 29, optical disk 31, ROM 24, or RAM 25, including an operating system 35, one or more application programs 36, other program modules 37, and program data 38. These program modules are used to program the one or more processors of computing system 20 to perform the processes described herein. A user may enter commands and information in computing system 20 and provide control input through input devices, such as a keyboard 40 and a pointing device 42. Pointing device 42 may include a mouse, stylus, wireless remote control, or other pointer, but in connection with the present invention, such conventional pointing devices may be omitted, since the user can employ the interactive display for input and control. As used hereinafter, the term “mouse” is intended to encompass virtually any pointing device that is useful for controlling the position of a cursor on the screen. Other input devices (not shown) may include a microphone, joystick, haptic joystick, yoke, foot pedals, game pad, satellite dish, scanner, or the like. These and other input/output (I/O) devices are often connected to processing unit 21 through an I/O interface 46 that is coupled to the system bus 23. The term I/O interface is intended to encompass each interface specifically used for a serial port, a parallel port, a game port, a keyboard port, and/or a universal serial bus (USB).

System bus 23 is also connected to a camera interface 59 and video adaptor 48. Camera interface 59 is coupled to interactive display 60 to receive signals from a digital video camera (or other sensor) that is included therein, as discussed below. The digital video camera may be instead coupled to an appropriate serial I/O port, such as to a USB port. Video adaptor 58 is coupled to interactive display 60 to send signals to a projection and/or display system.

Optionally, a monitor 47 can be connected to system bus 23 via an appropriate interface, such as a video adapter 48; however, the interactive display of the present invention can provide a much richer display and interact with the user for input of information and control of software applications and is therefore preferably coupled to the video adaptor. It will be appreciated that computers are often coupled to other peripheral output devices (not shown), such as speakers (through a sound card or other audio interface—not shown) and printers.

The present invention may be practiced on a single machine, although computing system 20 can also operate in a networked environment using logical connections to one or more remote computers, such as a remote computer 49. Remote computer 49 may be another PC, a server (which is typically generally configured much like computing system 20), a router, a network PC, a peer device, or a satellite or other common network node, and typically includes many or all of the elements described above in connection with computing system 20, although only an external memory storage device 50 has been illustrated in FIG. 1. The logical connections depicted in FIG. 1 include a local area network (LAN) 51 and a wide area network (WAN) 52. Such networking environments are common in offices, enterprise wide computer networks, intranets, and the Internet.

When used in a LAN networking environment, computing system 20 is connected to LAN 51 through a network interface or adapter 53. When used in a WAN networking environment, computing system 20 typically includes a modem 54, or other means such as a cable modem, Digital Subscriber Line (DSL) interface, or an Integrated Service Digital Network (ISDN) interface for establishing communications over WAN 52, such as the Internet. Modem 54, which may be internal or external, is connected to the system bus 23 or coupled to the bus via I/O device interface 46, i.e., through a serial port. In a networked environment, program modules, or portions thereof, used by computing system 20 may be stored in the remote memory storage device. It will be appreciated that the network connections shown are exemplary and other means of establishing a communications link between the computers may be used, such as wireless communication and wide band network links.

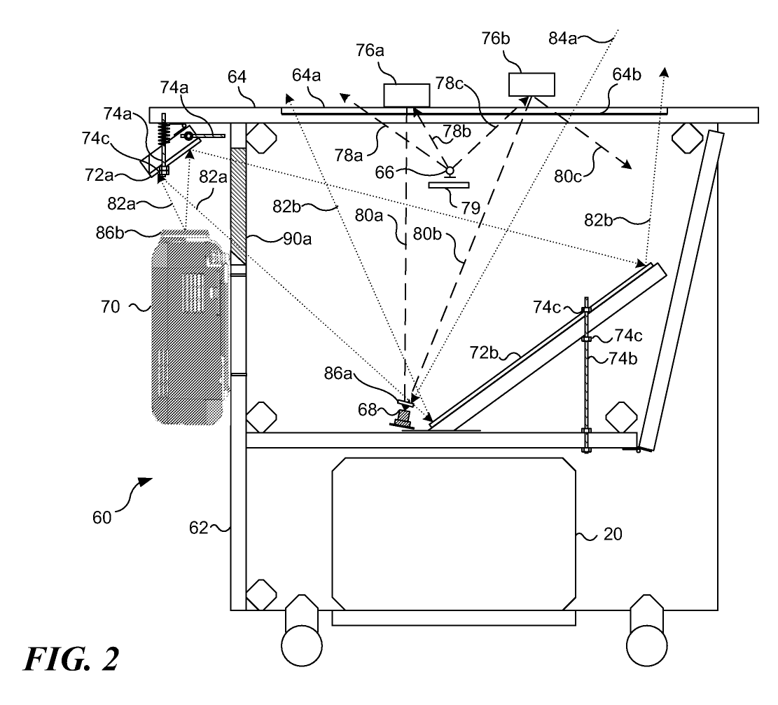

FIG. 2 provides additional details of an exemplary interactive display 60, which is implemented as part of a display table that includes computing system 20 within a frame 62 and which serves as both an optical input and video display device for computing system 20. In this cut-away drawing of the interactive display table, rays of light used for displaying text and graphic images are generally illustrated using dotted lines, while rays of infrared (IR) light used for sensing objects adjacent to (e.g., on or just above) display surface 64a of the interactive display table are illustrated using dash lines. Display surface 64a is set within an upper surface 64 of the interactive display table. The perimeter of the table surface is useful for supporting a user's arms or other objects, including objects that may be used to interact with the graphic images or virtual environment being displayed on display surface 64a.

IR light sources 66 preferably comprise a plurality of IR light emitting diodes (LEDs) and are mounted on the interior side of frame 62. The IR light that is produced by IR light sources 66 is directed upwardly toward the underside of display surface 64a, as indicated by dash lines 78a, 78b, and 78c. The IR light from IR light sources 66 is reflected from any objects that are atop or proximate to the display surface after passing through a translucent layer 64b of the table, comprising a sheet of vellum or other suitable translucent material with light diffusing properties. Although only one IR source 66 is shown, it will be appreciated that a plurality of such IR sources may be mounted at spaced apart locations around the interior sides of frame 62 to prove an even illumination of display surface 64a. The infrared light produced by the IR sources may exit through the table surface without illuminating any objects, as indicated by dash line 78a or may illuminate objects adjacent to the display surface 64a. Illuminating objects adjacent to the display surface 64a include illuminating objects on the table surface, as indicated by dash line 78b, or illuminating objects a short distance above the table surface but not touching the table surface, as indicated by dash line 78c.

Objects adjacent to display surface 64a include a “touch” object 76a that rests atop the display surface and a “hover” object 76b that is close to but not in actual contact with the display surface. As a result of using translucent layer 64b under the display surface to diffuse the IR light passing through the display surface, as an object approaches the top of display surface 64a, the amount of IR light that is reflected by the object increases to a maximum level that is achieved when the object is actually in contact with the display surface.

A digital video camera 68 is mounted to frame 62 below display surface 64a in a position appropriate to receive IR light that is reflected from any touch object or hover object disposed above display surface 64a. Digital video camera 68 is equipped with an IR pass filter 86a that transmits only IR light and blocks ambient visible light traveling through display surface 64a along dotted line 84a. A baffle 79 is disposed between IR source 66 and the digital video camera to prevent IR light that is directly emitted from the IR source from entering the digital video camera, since it is preferable that this digital video camera should produce an output signal that is only responsive to the IR light reflected from objects that are a short distance above or in contact with display surface 64a and corresponds to an image of IR light reflected from objects on or above the display surface. It will be apparent that digital video camera 68 will also respond to any IR light included in the ambient light that passes through display surface 64a from above and into the interior of the interactive display (e.g., ambient IR light that also travels along the path indicated by dotted line 84a).

IR light reflected from objects on or above the table surface may be: reflected back through translucent layer 64b, through IR pass filter 86a and into the lens of digital video camera 68, as indicated by dash lines 80a and 80b; or reflected or absorbed by other interior surfaces within the interactive display without entering the lens of digital video camera 68, as indicated by dash line 80c.

Translucent layer 64b diffuses both incident and reflected IR light. Thus, as explained above, “hover” objects that are closer to display surface 64a will reflect more IR light back to digital video camera 68 than objects of the same reflectivity that are farther away from the display surface. Digital video camera 68 senses the IR light reflected from “touch” and “hover” objects within its imaging field and produces a digital signal corresponding to images of the reflected IR light that is input to computing system 20 for processing to determine a location of each such object, and optionally, the size, orientation, and shape of the object. It should be noted that a portion of an object (such as a user's forearm) may be above the table while another portion (such as the user's finger) is in contact with the display surface. In addition, an object may include an IR light reflective pattern or coded identifier (e.g., a bar code) on its bottom surface that is specific to that object or to a class of related objects of which that object is a member. Accordingly, the imaging signal from digital video camera 68 can also be used for detecting each such specific object, as well as determining its orientation, based on the IR light reflected from its reflective pattern, or based upon the shape of the object evident in the image of the reflected IR light, in accord with the present invention. The logical steps implemented to carry out this function are explained below.

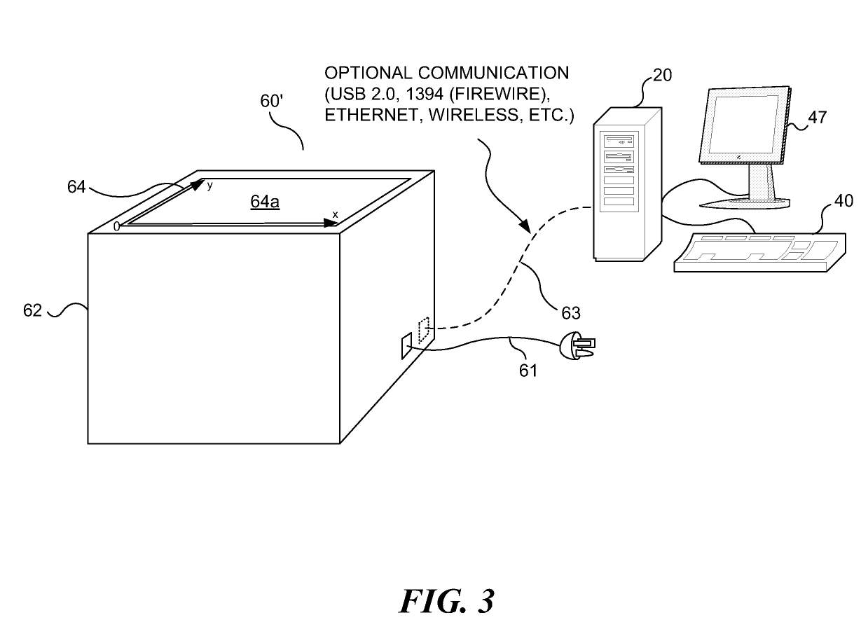

Computing system 20 may be integral to interactive display table 60 as shown in FIG. 2, or alternatively, may instead be external to the interactive display table, as shown in the embodiment of FIG. 3. In FIG. 3, an interactive display table 60′ is connected through a data cable 63 to an external computing system 20 (which includes optional monitor 47, as mentioned above). As also shown in this figure, a set of orthogonal X and Y axes are associated with display surface 64a, as well as an origin indicated by “0.” While not discretely shown, it will be appreciated that a plurality of coordinate locations along each orthogonal axis can be employed to specify any location on display surface 64a.

If the interactive display table is connected to an external computing system 20 (as in FIG. 3) or to some other type of external computing device, such as a set top box, video game, laptop computer, or media computer (not shown), then the interactive display table comprises an input/output device. Power for the interactive display table is provided through a power cable 61, which is coupled to a conventional alternating current (AC) source (not shown). Data cable 63, which connects to interactive display table 60′, can be coupled to a USB port, an Institute of Electrical and Electronics Engineers (IEEE) 1394 (or Firewire) port, or an Ethernet port on computing system 20. It is also contemplated that as the speed of wireless connections continues to improve, the interactive display table might also be connected to a computing device such as computing system 20 via a high speed wireless connection, or via some other appropriate wired or wireless data communication link. Whether included internally as an integral part of the interactive display, or externally, computing system 20 executes algorithms for processing the digital images from digital video camera 68 and executes software applications that are designed to use the more intuitive user interface functionality of interactive display table 60 to good advantage, as well as executing other software applications that are not specifically designed to make use of such functionality, but can still make good use of the input and output capability of the interactive display table. As yet a further alternative, the interactive display can be coupled to an external computing device, but include an internal computing device for doing image processing and other tasks that would then not be done by the external PC.

An important and powerful feature of the interactive display table (i.e., of either embodiments discussed above) is its ability to display graphic images or a virtual environment for games or other software applications and to enable an interaction between the graphic image or virtual environment visible on display surface 64a and identify objects that are resting atop the display surface, such as a object 76a, or are hovering just above it, such as a object 76b.

Referring to FIG. 2, interactive display table 60 includes a video projector 70 that is used to display graphic images, a virtual environment, or text information on display surface 64a. The video projector is preferably of a liquid crystal display (LCD) or digital light processor (DLP) type, or a liquid crystal on silicon (LCOS) display type, with a resolution of at least 640×480 pixels (or more). An IR cut filter 86b is mounted in front of the projector lens of video projector 70 to prevent IR light emitted by the video projector from entering the interior of the interactive display table where the IR light might interfere with the IR light reflected from object(s) on or above display surface 64a. A first mirror assembly 72a directs projected light traveling from the projector lens along dotted path 82a through a transparent opening 90a in frame 62, so that the projected light is incident on a second mirror assembly 72b. Second mirror assembly 72b reflects the projected light onto translucent layer 64b, which is at the focal point of the projector lens, so that the projected image is visible and in focus on display surface 64a for viewing.

Alignment devices 74a and 74b are provided and include threaded rods and rotatable adjustment nuts 74c for adjusting the angles of the first and second mirror assemblies to ensure that the image projected onto the display surface is aligned with the display surface. In addition to directing the projected image in a desired direction, the use of these two mirror assemblies provides a longer path between projector 70 and translucent layer 64b, and more importantly, helps in achieving a desired size and shape of the interactive display table, so that the interactive display table is not too large and is sized and shaped so as to enable the user to sit comfortably next to it.

Objects that are adjacent to (e.g., on or near) displays surface are sensed by detecting the pixels comprising a connected component in the image produced by IR video camera 68, in response to reflected IR light from the objects that is above a predefined intensity level. To comprise a connected component, the pixels must be adjacent to other pixels that are also above the predefined intensity level. Different predefined threshold intensity levels can be defined for hover objects, which are proximate to but not in contact with the display surface, and touch objects, which are in actual contact with the display surface. Thus, there can be hover connected components and touch connected components. Details of the logic involved in identifying objects, their size, and orientation based upon processing the reflected IR light from the objects to determine connected components are set forth in United States Patent Application Publications 2005/0226505 and 2006/0010400, both of which are incorporated herein by reference in their entirety.

As a user moves one or more fingers of the same hand across the display surface of the interactive table, with the fingers tips touching the display surface, both touch and hover connected components are sensed by the IR video camera of the interactive display table. The finger tips are recognized as touch objects, while the portion of the hand, wrist, and forearm that are sufficiently close to the display surface, are identified as hover object(s). The relative size, orientation, and location of the connected components comprising the pixels disposed in these areas of the display surface comprising the sensed touch and hover components can be used to infer the position and orientation of a user's hand and digits (i.e., fingers and/or thumb). As used herein and in the claims that follow, the term “finger” and its plural form “fingers” are broadly intended to encompass both finger(s) and thumb(s), unless the use of these words indicates that “thumb” or “thumbs” are separately being considered in a specific context.

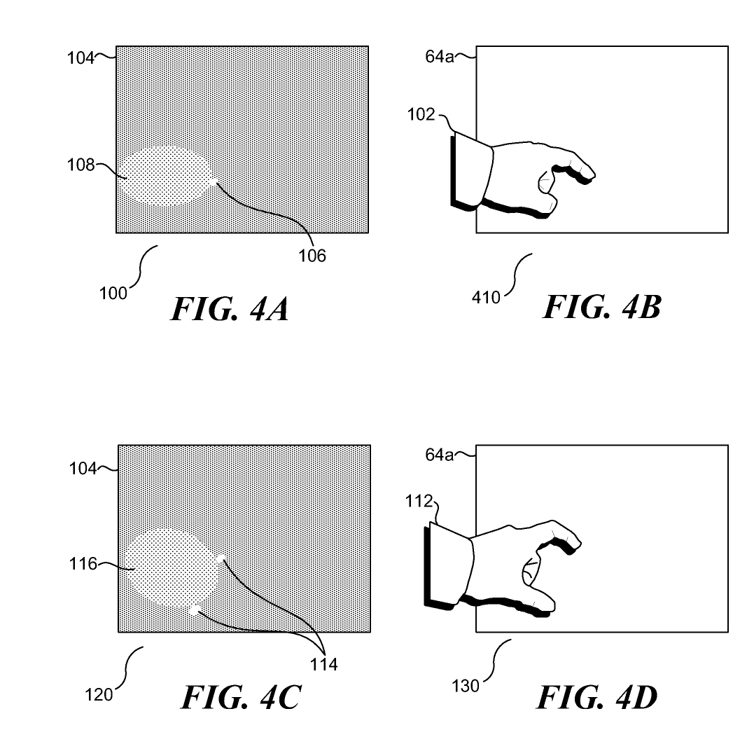

In FIG. 4A, an illustration 400 shows, in an exemplary manner, a sensed input image 404. Note that the image is sensed through the diffusing layer of the display surface. The input image comprises a touch connected component 406 and a hover connected component 408. In FIG. 4B, an illustration 410 shows, in an exemplary manner, an inferred hand 402 above the display surface that corresponds to hover connected component 408 in FIG. 4A. The index finger of the inferred hand is extended and the tip of the finger is in physical contact with the display surface whereas the remainder of the finger and hand is not touching the display surface. The finger tip that is in contact with the display surface thus corresponds to touch connected component 406.

Similarly, in FIG. 4C, an illustration 420 shows, in an exemplary manner, a sensed input image 404. Again, the image of the objects above and in contact with the display surface is sensed through the diffusing layer of the display surface. The input image comprises two touch connected components 414, and a hover connected component 416. In FIG. 4D, an illustration 430 shows, in an exemplary manner, an inferred hand 412 above the display surface. The index finger and the thumb of the inferred hand are extended and in physical contact with the display surface, thereby corresponding to touch connected components 414, whereas the remainder of the fingers and the hand are not touching the display surface and therefore correspond to hover connected component 416.

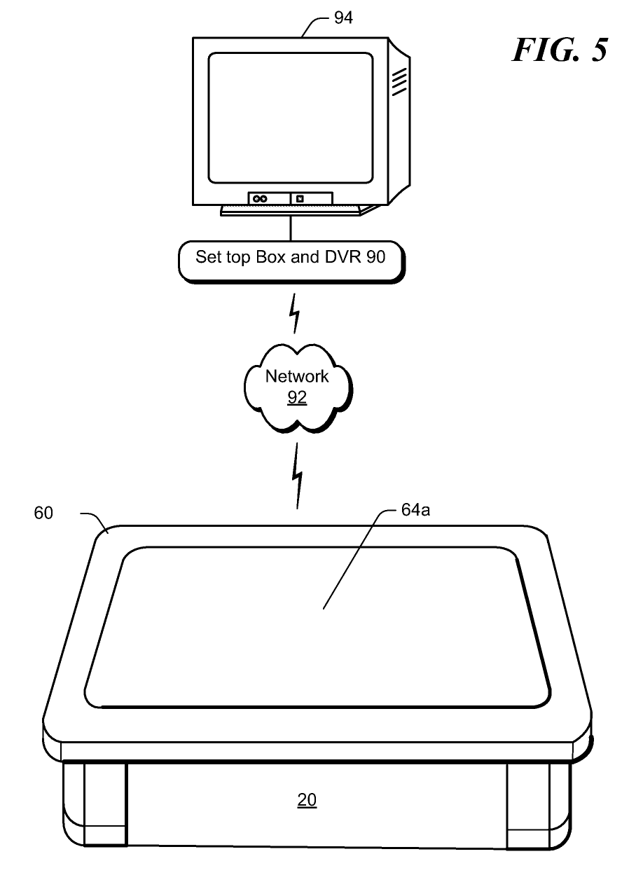

FIG. 5 depicts computing system 20 (with interactive display 60 and display surface 64a) in communication with a content presentation system via network 92. In one embodiment, the content presentation system includes a television (or video monitor) 94 and an integrated set top box and digital video recorder (DVR) 90. In other embodiments, the set top box and DVR can be separate components. Other types of content presentation systems (including stereos, computers etc) can also be used. Network 92 can be a LAN, WAN, wireless network or other type of communication medium.

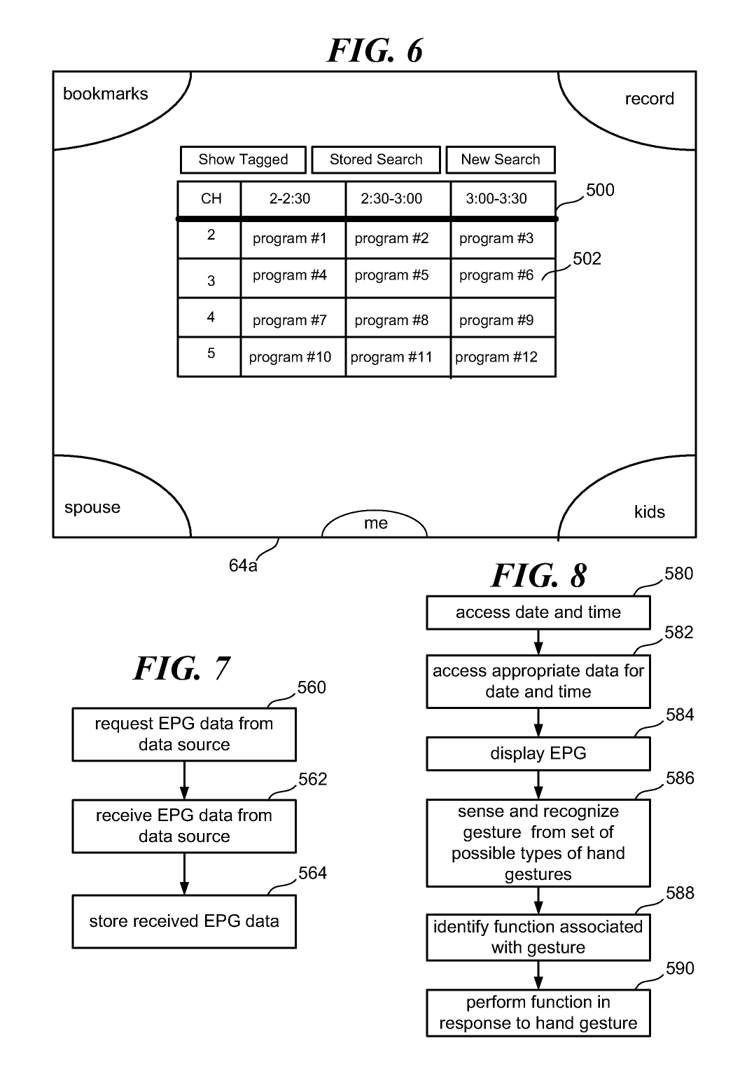

One example of an application that can be used with interactive display 60 is an electronic program guide (“EPG”). FIG. 6 shows display surface 64a providing one embodiment of an EPG. In the center of display surface 64a is a grid 500 which includes a set of rows depicting television shows being broadcast by the appropriate channels at the listed times. The first column indicates the channel and the remaining columns pertain to time slots. Grid 500 of FIG. 6 includes scheduling for show #1-show #12. In actual implementations, rather than the label “show #1,” the title of the show would be listed. In other embodiments, other forms of an EPG can be used that are different than a grid. In addition to grid 500, display surface shows three buttons: “Show Tagged,” “Stored Search” and “New Search.” The EPG described herein allows a user to tag a set of shows. By then selecting the “Show Tagged” button, all those programs that were tagged by the user will be displayed. This feature will be described in more detail below. By pressing the “New Search” button, the user will be allowed to enter search criteria and the EPG will search for shows that meet that criteria. Alternatively, the user can have a user profile with stored search criteria. By pressing the “Stored Search” button, EPG run the search using the stored criteria.

Although FIG. 6 depicts the EPG as a grid, the EPG can be in many other formats and can include different sets of information. For example, an EPG can also include image or video representation of content (such as an image from the show, poster art, the actual trailer playing, etc.). An EPG can also be used to provide information about audio programs, programs on private systems (as opposed to broadcast networks), and other types of content. An EPG can also be used for video on demand services.

Display surface 64a also includes five collection areas: bookmarks, record, spouse, kids, and me. By dragging programs to those collection areas, various functions will be performed, as discussed below.

In order to provide the EPG of FIG. 6, computing system 20 will obtain EPG data and create the EPG. FIG. 7 is a flow chart describing one embodiment of such a process. In step 560, computing system 20 will request EPG data from a data source. For example, a server available on the Internet can provide EPG data. Computing system 20 will contact that server and request the appropriate data based on the current time and date. In one embodiment, computer 20 will request two weeks worth of data. In step 562 of FIG. 7, the requested EPG data is received. In step 564, the requested EPG data that has been received in step 562 is then stored. For example, the data can be stored on hard disk drive 27 of computing system 20.

FIG. 8 is a flow chart describing one embodiment of interactive display 60 and computing device 20 operating the EPG of FIG. 6. In step 580, computer system 20 automatically accesses the current date and time. In one embodiment, computer system 20 keeps track of the date and time using an internal clock or other device. In other embodiments, computer system 20 will access the date and time from a source on the Internet or other device on a local LAN. In step 582, computer system 20 will automatically access the appropriate EPG data from hard disk drive 27 based on the current date and time. In step 584, interactive display 60 and computing device 20 will automatically create and display grid 500 (or another structure), as depicted in FIG. 6. In step 586, interactive display 60 and computer system 20 will automatically sense hand gestures (or gestures using other parts of the body) adjacent display surface 64. In one embodiment, interactive display 60 and computing device 20 will be able to detect many different types of hand gestures. Step 586 includes determining which of the many different types of hand gestures were just performed adjacent to the display surface 64a.

No one particular set of gestures is required with the technology described herein. The set of gestures used will depend on the particular implementation. An example list (but not exhaustive) of types of gestures that can be used include tapping a finger, tapping a palm, tapping an entire hand, tapping an arm, tapping multiple fingers, multiple taps, rotating a hand, flipping a hand, sliding a hand and/or arm, throwing motion, spreading out fingers or other parts of the body, squeezing in fingers or other parts of the body, using two hands to perform any of the above, drawing letters, drawing numbers, drawing symbols, performing any of the above gestures using different speeds, and/or performing multiple gestures of the above-described gestures concurrently. The above list includes sliding and throwing. In one embodiment, sliding is moving a finger, fingers or hand across display screen 64a from one icon to another. On the other hand, throwing includes moving a finger, fingers or hand across display screen 64a from one icon to the edge of display screen 64a without terminating necessarily at another icon.

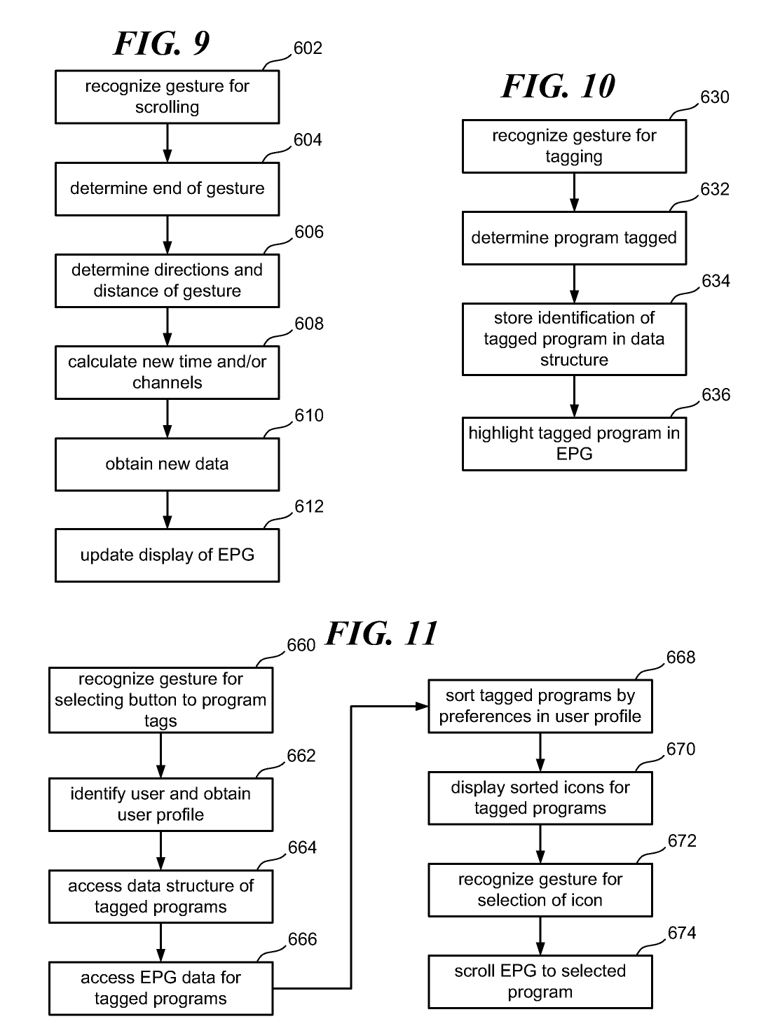

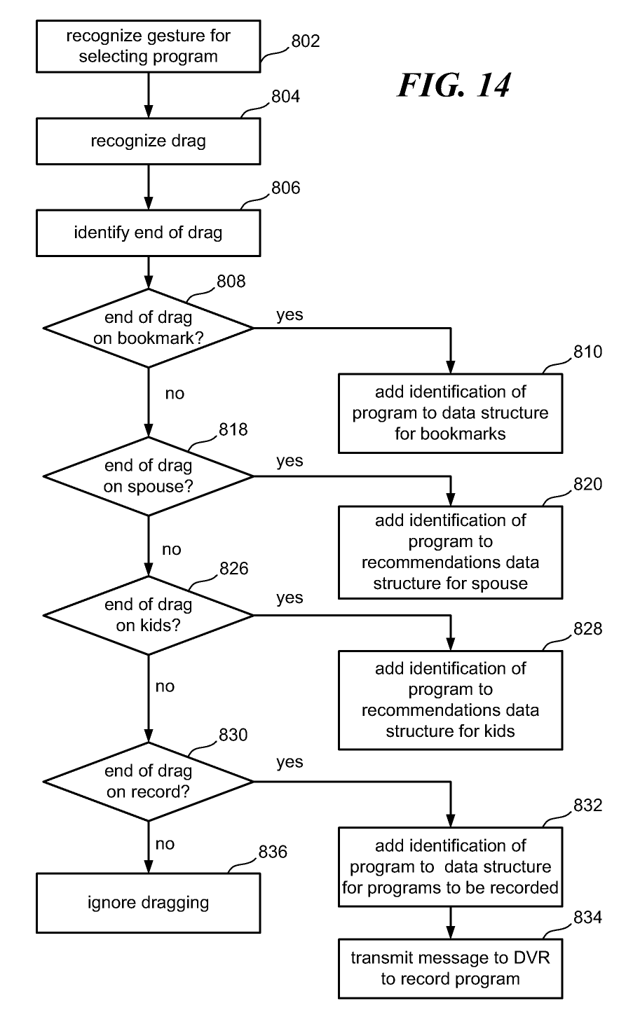

Step 588 of FIG. 8 includes interactive display 60 and computing device 20 automatically identifying a function associated with the sensed gesture. There are various functions that can be performed by the EPG described herein. No particular set of functions is required. Some examples of functions (but not exhaustive) include tagging or untagging a program, recommending a program to someone else, adding a program to a favorites list, adding a program to a playlist, watching a preview, getting more information about a program, watching the program now, scheduling the program to be watched later, scheduling the program for recording (DVR, tape, etc.), deleting a program (e.g., in response to drawing an X), sorting programs, reorganizing the EPG, manipulating or otherwise changing the EPG, scrolling the EPG, sending the program to be viewed at another device (e.g., television, DVR, etc.) or searching the EPG. Other functions can also be performed. In step 590, the function identified in step 588 is automatically performed in response to the hand gesture. Although the above discussion describes the gesture being a hand gesture, the gesture can be performed by other parts of the body. The gestures need not be made by a human. FIGS. 9-23 provide more detail for various embodiments for steps 586-590.

FIG. 5 is a flow chart describing one embodiment of a process for sensing the gesture that indicates the EPG should be scrolled and scrolling in response thereto. In step 602 of FIG. 9, interactive display 60 and computing device 20 will recognize a particular gesture meant for scrolling. In one embodiment, the gesture could include a finger, multiple fingers, or hand being on top of grid 500 and sliding. Other gestures can also be used. In step 604, interactive display 60 and computing device 20 determine when the gesture has ended. In step 606, interactive display 60 and computing device 20 determine the direction and distance of the gesture. After determining the direction and distance, computing device 20 will calculate which part of the grid needs to be displayed by determining the appropriate time slots and channels. In step 610, computing device 20 will obtain the appropriate data from hard drive 27. In step 612, computing device 20 and interactive display 60 will update the display of EPG by providing new updated grid 500.

While the grid 500 is being displayed, the user can tag any of the programs displayed. In one embodiment, a program is tagged by selecting it (e.g., touching the image on the grid representing the show). A program that is already tagged can be untagged by selecting it. FIG. 10 is a flow chart describing one embodiment for tagging. A similar process can be used for untagging a program. In step 630 of FIG. 10, interactive display 60 and computing device 20 will recognize the gesture for tagging. In one embodiment, the gesture for tagging could include using one finger, multiple fingers or a hand to touch the area of display surface 64a displaying the information about a program. For example, touching box 502 will be understood as an indication that the user wants to tag Program #6. In step 632, computing device 20 and interactive display 60 will determine which program was tagged. That is, upon sensing that a tagging gesture was performed, the system will determine which pixels are under the user's hand and which program those pixels pertain to. In step 634, an identification of the tag shall be stored in a data structure of tagged shows. For example, computing device 20 can keep any of a various number of data structures. Each entry in the data structure of tagged shows will have a pointer to the appropriate EPG data in hard drive 27. In step 636, computer device 20 will cause interactive display 60 to highlight the show that has been tagged. In one embodiment, box 502 can then be displayed in a different color, with a thicker border, with a shadow, with an icon indicating a tag, etc.

FIG. 11 describes one embodiment of a process performed when the user requests to see all the programs that have been tagged. In step 660, computer device 20 and interactive display 60 will determine and recognize the gesture for selecting the button “Show Tagged.” For example, FIG. 6 depicts a “Show Tagged” button. In one embodiment, the gesture could include tapping the button. Other gestures can also be used.

In step 652, computing device 20 will identify the user who did the tapping and obtain that user's profile. Various means can be used for identifying the user. In one embodiment, the system can detect the user's fingerprints and compare that to a known set of fingerprints. In another embodiment, the system can detect the geometry of the user's hand. Alternatively, the system can determine the user based on RFID or other signal from a cell phone or other electronic device on the person of the user. Alternatively, the user can log in and provide a user name and password. Other types of identification could also be used.

In one embodiment, each user on the system has the opportunity to set up a user profile. In that user profile, the user can store a user name, password, viewing preferences, stored search criteria, and other information. The viewing preferences may indicate what types of programs the user prefers, and in what order. For example, the viewing preferences may indicate that the user prefers sporting events. After sporting events, the user likes to watch comedies. Within sporting events, the user may like all teams from one particular city or the user may prefer one particular sport. Other types of preferences can also be used. In regard to the stored search criteria, the user may identify genres, channels, actors, producers, country of origin, duration, time period of creation, language, audio format, etc. The various search criteria listed can also be used as to set viewing preferences.

Looking back at FIG. 11, in step 664, computer 20 will access the data structure of tagged shows (see step 634 of FIG. 10). That data structure will include a set of pointers to the EPG data for those shows on hard disk drive 27 (or other data storage device). In step 666, computer 20 will access the EPG data for those tagged shows. In step 668, computer 20 will sort the data according to the preferences in the user profile, discussed above. In one embodiment, if there is no user profile, the shows can be sorted by other criteria (e.g., alphabetically, time of broadcast, channel, etc.). In step 670, the icon for all the shows can be displayed in a dialog box or other type of window. In step 672, the user can select one of the icons. Computer device 20 and interactive display 60 will recognize the gesture for selecting the icon. Any one of a number of gestures can be used, including tapping, placing a palm, etc. Upon recognizing the gesture for selecting an icon, computer 20 will then scroll the grid 500 so that the selected show (from step 672) is at the upper left-hand corner (or other position) in a viewable portion of grid 500.

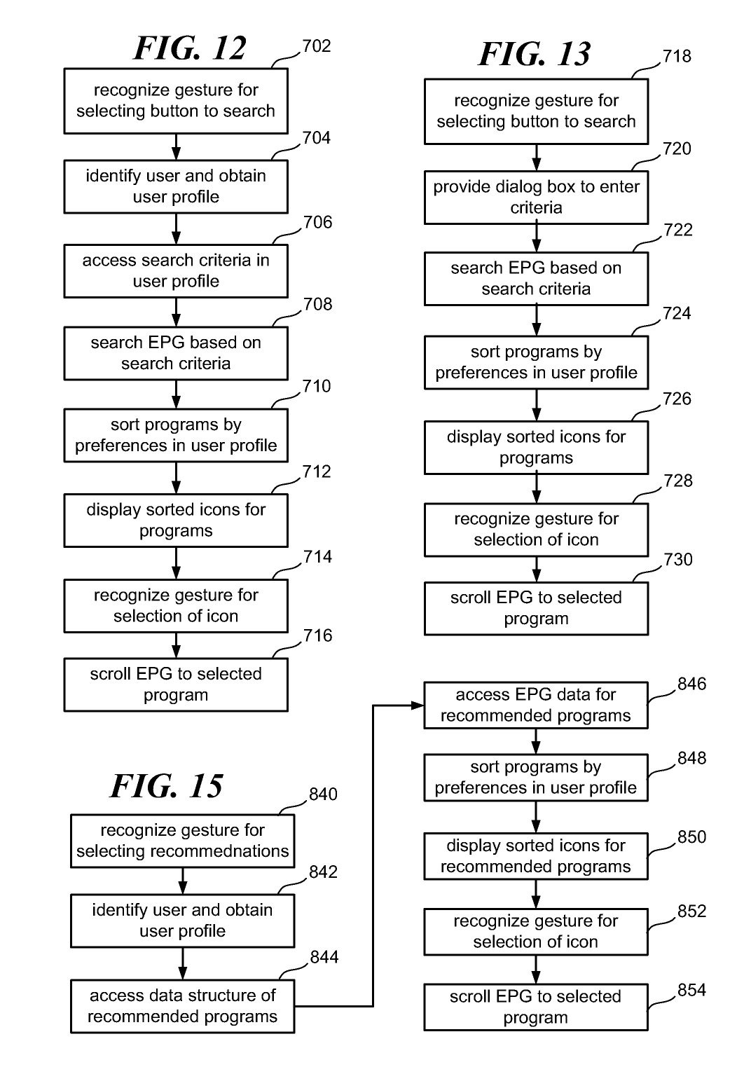

FIG. 12 is a flow chart describing one embodiment of a process performed when a user selects to perform a stored search. That is, the user selects the “Stored Search” button depicted in FIG. 6. In step 702, computing device 20 and interactive display 60 will recognize the gesture for selecting the “stored search” button. Examples of appropriate gestures include tapping one or more fingers and/or a hand. Other gestures can also be used. The system will determine that the gesture was performed on top of the “stored search” button. In step 704, computing device 20 will identify the user and obtain the user's profile. In step 706, computing device 20 will access the search criteria stored in the user profile. In step 708, computing device 20 will search the EPG data based on the search criteria accessed in step 706. In step 710, the programs that were identified in the search of step 708 are then sorted by the viewing preferences stored in the user profile. In step 712, the icons for the programs identified by the search will be displayed on display surface 64a as sorted. In step 714, computing device 20 and interactive display 60 will recognize the gesture for selecting one of the icons for the programs displayed. In step 716, the EPG will be scrolled to the selected program.

FIG. 13 is a flow chart describing one embodiment of a process performed when the user selects to perform a new search by selecting the “New Search” button depicted in FIG. 6. In step 718, computing device 20 and interactive display 60 recognize the gesture for selecting the “New Search” button. The gesture can be the same gestures used to select the “Stored Search” button or the “Show Tagged” button, but over the “New Search” button instead. In step 720, a dialog box will be provided to enter search criteria. For example, the user can enter title names, actor names, genres, creation time periods, channels, etc. In step 722, computing device 20 will search the EPG data based on the search criteria provided in step 720. In step 724, computing device 20 will sort the programs based on the viewing preferences in the user's profile. The user can be identified by any of the means discussed above. In step 726, interactive display 60 will display the icons for the sorted shows. In step 728, computing device 20 and interactive display 60 will recognize the gesture for selecting one of those icons (similar to step 714). In step 730, the EPG (grid 500) will be scrolled to the selected show, similar to step 674.

In one embodiment, the user can select any one of the shows depicted in grid 500 and drag that show to any of the collection areas. FIG. 6 shows five collection areas (bookmarks, record, spouse, kids, me); however, more or less than five collection areas can be used. In step 802 of FIG. 15, interactive display 60 and computing device 20 will recognize the gesture for selecting the show in the grid 500. In one embodiment, the gesture can include pointing with one finger, pointing with multiple fingers, or holding a hand over the show. For example, the user can point to box 502 to select Program #6. The use will then, while still touching display screen 64a above the program, drag the show to one of the collection areas by sliding the user's hand or fingers to the collection area in step 804. Computing device 20 and interactive display 60 will recognize the user dragging the user's hand. In step 806, computing device 20 and interactive display 60 will identify that the drag has been completed and will note the location of the completion of the drag. If the user ended the drag on the bookmarks collection area (step 808), then an identification of that show will be added to a data structure for a bookmark in step 810. If the drag ended at the spouse collection area (step 818), then identification of that program is added to the recommendations structure for the user's spouse in step 820. If the drag ended on the kids collection area (step 826), then an identification of the program is added to the recommendations data structure for the user's kids in step 828. If the drag ended on the record collection area (step 830), then an identification of the show is added to the data structure for shows to be recorded in step 832. In addition, in step 834, a message is transmitted from computing device 20 to the user's DVR (e.g., set top and DVR 90) in order to instruct the DVR to record the show. In one embodiment, the DVR can be part of the set top box that is connected to the same network as computer 20. A message is sent from computing device 20 to the DVR via the network. If the drag did not end at the bookmarks collection area, spouse collection area, kids collection area, or record collection area, then the drag can be ignored (step 836). In one embodiment, while the user is dragging, computer 20 and display 60 will cause the box 502 to be displayed as moving across display surface 64a underneath the user's finger or hand.

As discussed above, a user can add programs to a recommended list for the user's spouse or kids. In other embodiments, the system can be configured to add programs to recommended lists for other people (e.g., friends, acquaintances, etc.). Additionally, other people can add programs to the user's recommended list.

FIG. 15 is a flow chart describing one embodiment of a process used for the user to view those programs recommended to that user. In step 840, computing device 20 and interactive display 60 will recognize the gesture for selecting the user's recommendations. For example, the user may tap with one finger, tap with multiple fingers, or place a hand over the “me” collection area (see FIG. 6). In step 842, computing device 20 and interactive display 60 will identify the user (as discussed above) and obtain that user's profile. In step 844, computing device 20 will access the data structure for recommended shows for that particular user. In step 846, computing device 20 will access the EPG data in hard disk drive 27 (or other storage device) for all the recommended shows in the data structure. In step 848, computing device 20 will sort those shows by the viewing preferences in the user's profile. In step 850, the sorted shows will be displayed on interactive display 60. In step 852, computing device 20 and interactive display 60 will recognize the gesture for selecting one of the icons associated with one of the shows displayed in step 850. Step 852 is similar to step 672. In step 854, computing device 20 and interactive display 60 will scroll the EPG to the selected show (similar to step 674).

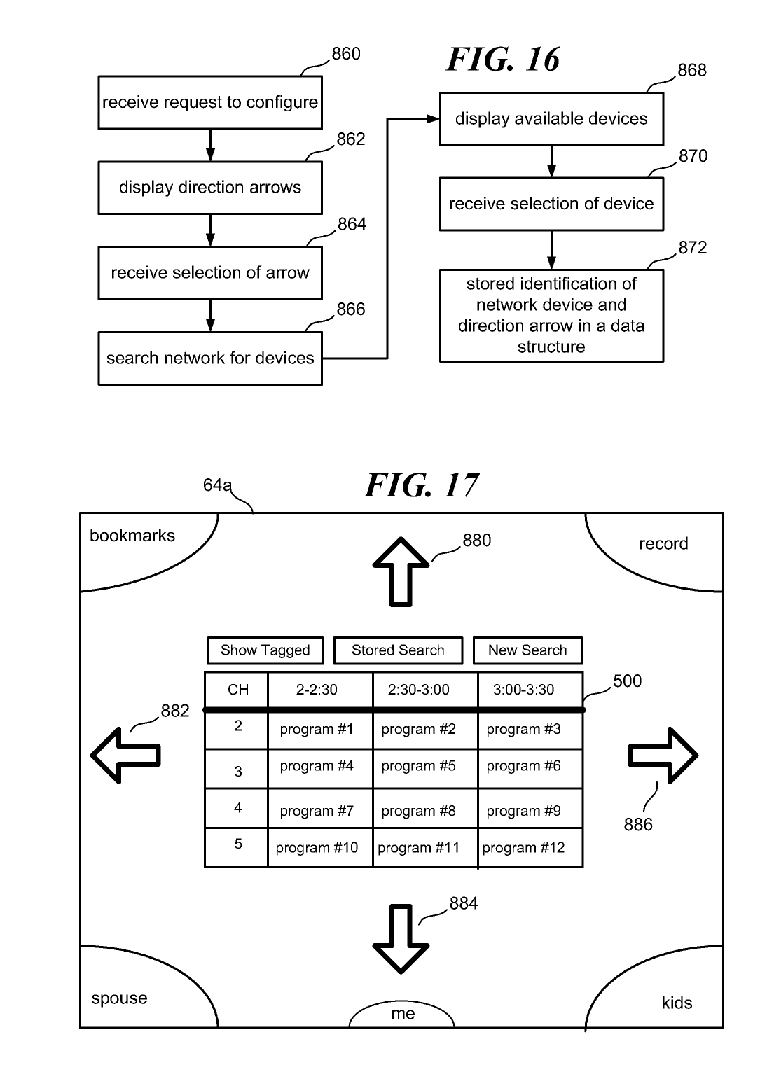

One function that a user can perform is to request that another viewing device be used to view a program. In one embodiment, the user will be provided with a graphical depiction of a network and a user can drag an icon for the program to the device on the network. In another embodiment, the user can throw the icon for a program off of display surface 64a in the direction of the device the user wants to view the program on. For example, looking back at FIG. 6, the user can put the user's hand over box 502 and then slide the hand very fast off display surface 64a in the direction of a television (or stereo or other content presentation device). In response to that throwing motion, computing system 20 will send a command to the television to play the selected program. In order to enable such a feature, a setup process must be performed. FIG. 16 is a flow chart describing one embodiment of an appropriate setup process. In step 860, the user will request to configure this feature. Various means can be used to request to configure, including using a gesture to indicate a configuration menu. In step 862, computing device 20 and interactive display 60 will cause a set of arrows to be displayed on display surface 64a. For example, FIG. 17 shows arrows 880, 882, 884 and 886 displayed on display surface 64a. Note that the embodiment of FIG. 17 only shows four arrows indicating four directions. In other embodiments, there can be more than four arrows to indicate finer granulations of direction. In step 864, the user will select one of the arrows by touching the arrow and that selection will be received by interacting display 60 and computing device 20. In step 866, computing device 20 will search its local LAN for all computing devices that it can communicate with. In other embodiments, computing device 20 can search other networks that are accessible via any one of various communication means. In step 868, all the devices found in step 866 will be displayed in a graphical form on display surface 64a. In step 870, the user will select one of those devices. The device selection in step 870 will then be paired up with arrows selected in step 864. This will enable the user to throw an icon for a program in the direction of a selected arrow and that program will then be provided in the device selected in step 870. In step 872, identifications of the network device and the direction arrow are both stored. In alternative embodiments, the process of FIG. 16 can be completely automated by using GPS receivers to automatically identify where computing devices are.

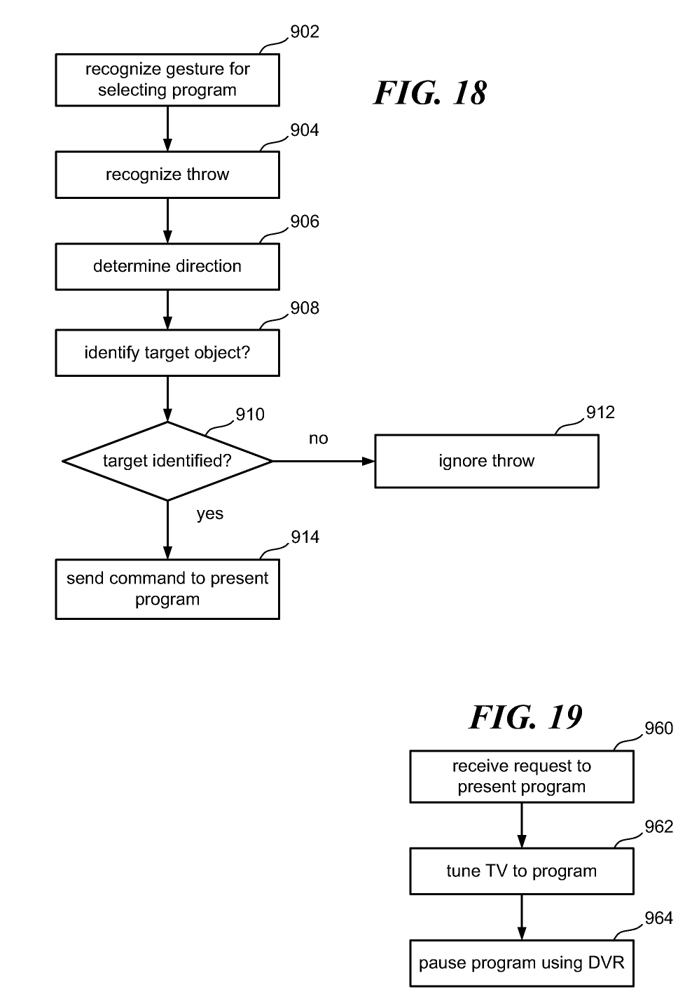

FIG. 18 is a flow chart describing one embodiment of a process for throwing a program to another content presentation device. In one embodiment, the process of FIG. 18 would be performed after the process of FIG. 16. In step 902, computing device 20 and interactive display 60 recognize the gesture for selecting a show. For example, the user can tap with one finger, tap with multiple fingers, place a hand over a show, etc. In step 904, the user will throw the icon for the show and that throwing will be recognized in step 904. For example, the user can select box 502 (see FIG. 6) and quickly slide the user's hand from box 502 to the edge of display surface 64a. In step 906, computing device 20 will determine the direction and identify the most appropriate arrow (see FIG. 17). In step 908, computing device 20 will identify the target based on which network device was associated with the arrow (see step 872 of FIG. 16). If a target was not identified (step 910), then the throwing motion is ignored (step 912). If a target was identified (step 910), then a command is sent to the target device to present the program in step 914. For example, computing device 20 will communicate with set top box 90 to instruct set top box 90 to present the program selected by the user non television 94.

FIG. 19 is a flow chart describing one embodiment of a process performed by the set top box (or other device) when receiving a request to play a program (in response to step 914 of FIG. 18). In step 960 of FIG. 19, the set top box (or other device) will receive the request to present the program. For example, the request received in step 960 is the command sent in step 914 of FIG. 18 via network 92. In step 962, the television will be tuned to the program requested. In step 964, the program will be paused. In one embodiment, the set top box includes a DVR (or is connected to a DVR. The DVR will be used to pause the programs so that the user has time to appropriately position the user to view the show. Subsequent to step 964, the user can use a remote control or other device to un-pause the DVR and watch the program.

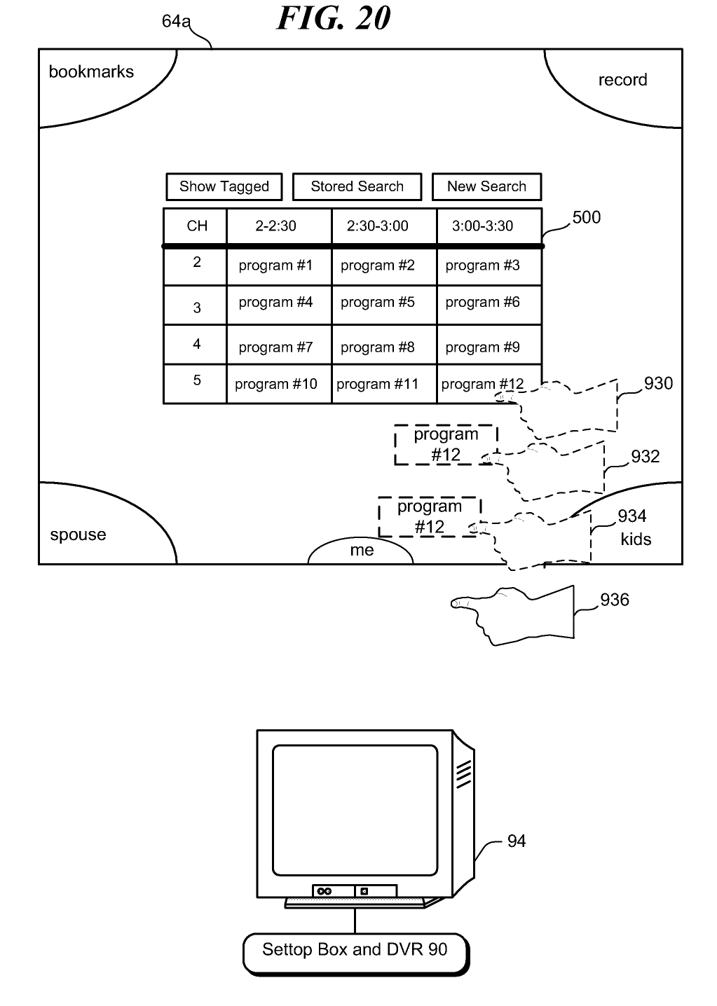

FIG. 20 graphically depicts a user throwing a program in accordance with the process of FIG. 18. In this example, the user has selected program #12. After selecting program #12, the user slides the user's hand in the direction of television 94 which is connected to set top box and DVR 90. FIG. 20 shows the hand during various points of the throwing motion. For example, at point 930, the hand is first selecting program #12 and will start the throwing motion. At point 932, the thrwomg motion is underway and the icon for program #12 have been moved from grid 500 toward TV 94. At point 934, the icon for program #12 is closer to the edge of display surface 64a. After the hand goes over the edge of display surface 64a, the system is no longer able to display the icon for program #12 underneath the hand. Thus, the hand is shown at point 936 without an icon. As can be seen, the hand going from point 930 to point 936 is moving in a motion toward TV 94.

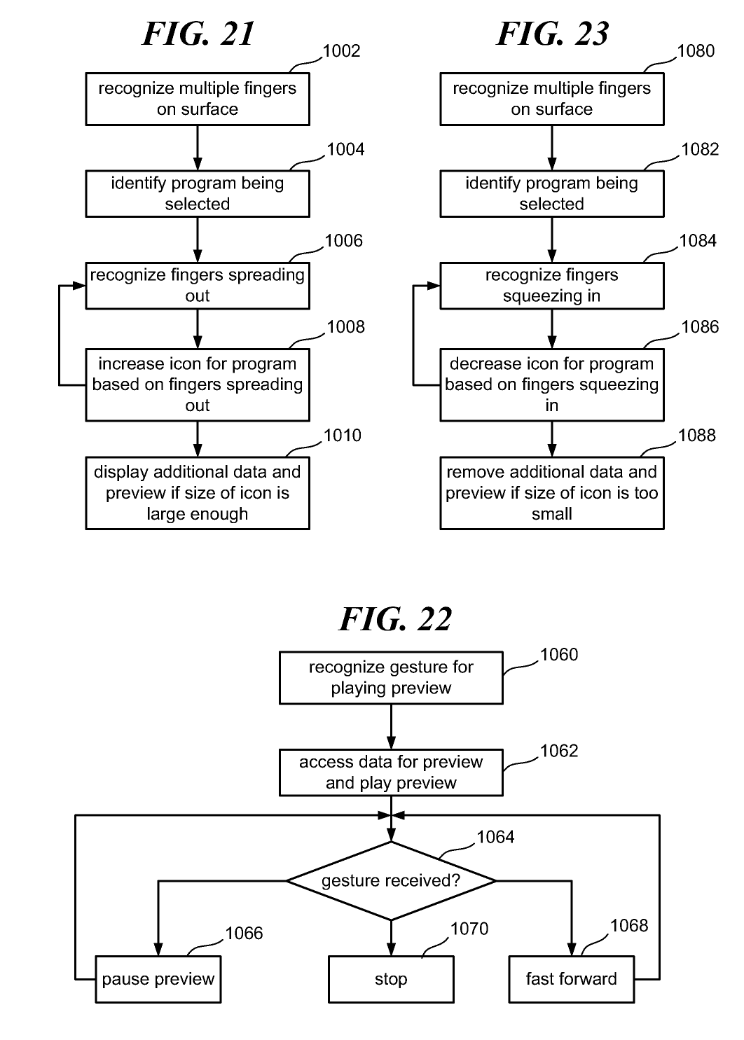

Another function the user can perform is to make an icon for a program bigger. In response to making the icon (or other type of image bigger), more information for that program and/or or a preview for that program can be displayed in or near the icon. FIG. 21 is a flow chart describing one embodiment of a process for performing those functions. In step 1002, computing device 20 and interactive display 60 will recognize multiple fingers on display surface 64a. In step 1004, computing device 20 will determine which program (or other item) is being selected based on the location of the fingers. In step 1006, interactive display 60 and computing device 20 will recognize that the fingers recognized at step 1002 are now spreading out to become wider apart. In step 1008, in response to step 1006, the icon for the show being selected (see step 1004) is increased in size. The user can continue to make the user's fingers wider apart, in which steps 1006, 1008 will be repeated. When the icon for the show is big enough, additional data will be displayed inside the icon. For example, when the icon is in grid 500, the icon may only indicate the title of the show. When the icon is big enough, computing device 20 and interactive display 60 may add such additional information as actors, genre, synopsis, rating, etc. Additionally, a preview icon can be added in the original icon. The preview icon is similar to picture-in-picture (PIP). By the user selecting the preview icon, the user can operate the preview. Note that in other embodiments, different body parts (other than fingers) can be spread apart to make an item bigger.

FIG. 22 is a flow chart describing one embodiment for operating the preview icon. In step 1060, computing device 20 and interactive display 60 will recognize the gesture for playing a preview. For example, the gesture may be a user tapping with one finger, tapping with multiple fingers, placing a palm over the icon, moving the fingers in a particular direction, drawing the letter P (or other letter or symbol), etc. In step 1062, data for that preview is accessed by computing device 20 from hard drive 27 (or other storage device). For example, computing device 20 may store a set of videos that are previews for various shows. That video will be accessed at step 1062 and played in the picture-in-picture icon. While that video is playing, the user can perform a number of gestures. In one embodiment, the user can provide a gesture for pausing the video, stopping the video, or fast forwarding the video. Any one of the gestures described above can be used for any one of these functions. If the user provides a gesture for pausing the video (step 1064), then the video will be paused in step 1066 and the process will loop back to wait for the next gesture (step 1064). If the user chose to fast forward the video, then in step 1068 the video will be fast-forwarded by a predefined amount of time and the system will then begin playing the video from that new location. If the user chose to stop the video, then the video will be stopped in step 1070.

FIG. 23 is a flow chart describing a process performed when the user wants to make an icon smaller. In step 1080, the system will recognize multiple fingers on display surface 64a above an icon or other image or item. For example, the fingers can be on top of an icon made bigger by the process of FIG. 21A or any other image visible on display surface 64a. In step 1082, computing device 20 and interactive display 60 will determine the program being selected by the location of where the fingers are. In step 1084, interactive display 60 and computing device 20 will recognize that the user's fingers (or other body parts) are squeezing in (e.g., coming closer together). In response to the user's fingers squeezing in, computing device 20 and interactive display 60 will decrease the size of the icon of the program selected based on how far the user's fingers have squeezed in. The user can continue to squeeze the user's fingers together and the icon will continue to be decreased so that steps 1084 and 1086 will be repeated. When the icon gets small enough, any additional data or previews that are depicted in the icon will need to be removed.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

We claim:

1. A method of managing content, comprising:
displaying an electronic program guide on a first portion of a display surface;
automatically sensing an item adjacent to the first portion of the display surface;
automatically determining that a first type of gesture of a plurality of types of gestures is being performed by the item adjacent to the surface;
automatically identifying a function associated with the first type of gesture, the function includes manipulating the electronic program guide on the first portion of the display; and
performing the function, including changing the display of the electronic program guide on the first portion of the display.

2. The method of claim 1, wherein:
the first type of gesture includes sliding; and
the function includes scrolling the electronic program guide on the first portion of the display.

3. The method of claim 1, wherein:
the first type of gesture includes sliding; and
the function includes sliding an image associated with a show on the display in the direction of a television and, in response to the sliding, causing the show to be displayed on the television.

4. The method of claim 1, wherein:
the plurality of types of gestures includes throwing and sliding, wherein throwing is performed with a faster motion than sliding;
the first type of gesture is throwing; and
the function includes sliding an image associated with a show on the display in the direction of a television and causing the show to be displayed on the television.

5. The method of claim 1, wherein:
the first type of gesture includes sliding; and
the function includes sliding an image on the display in the direction of an object separate from the display and sending a message to the object to perform a function.

6. The method of claim 1, wherein:
the first type of gesture includes spreading out one or more parts of a body; and
the function includes increasing the size of an object being displayed as part of the electronic program guide on the display and displaying additional information within the object after increasing the size.

7. The method of claim 1, further comprising:
displaying a video within a graphical object being displayed as part of the electronic program guide, the function includes controlling the video.

8. The method of claim 1, wherein:
the first type of gesture includes sliding a body part on the surface from an icon for a program to a collection area;
the function includes inserting an entry into a data structure for the collection area, the entry includes an identification of a program;
the changing of the display includes moving an icon associated with the program toward the collection area; and
the method further includes receiving a request to access information associated with the collection area, accessing the data structure for the collection area and displaying programs identified in the data structure for the collection area.

9. The method of claim 1, further comprising:
accessing data and time information; and
accessing appropriate program data for the date and time, the displaying of the electronic program guide uses the program data, the first type of gesture is a hand gesture.

10. An apparatus for managing content, comprising:
one or more processors;
one or more storage devices in communication with the one or more processors;
a display surface in communication with the one or more processors, the one or more processors cause an electronic program guide to be displayed on the display surface; and
a sensor in communication with the one or more processors, the sensor senses presence of an object adjacent to the display surface, based on data received from the sensor the one or more processors are programmed to determine which gesture of a plurality of types of gestures is being performed by the object adjacent to the surface in an interaction with the electronic program guide, the one or more processor perform a function in response to the determined gesture.

11. The apparatus of claim 10, wherein:
the one or more processors determine that the gesture being performed includes a body part sliding across at least a portion of the display surface and the function performed by the one or more processors is scrolling the electronic program guide display surface.

12. The apparatus of claim 10, wherein:
the one or more processors determine that the gesture being performed includes a body part sliding across at least a portion of the display surface from an original location of an icon and toward a physical device separate from the display surface; and
the function performed by the one or more processors includes causing a program associated with the icon to be displayed on the physical device.

13. The apparatus of claim 10, wherein:
the one or more processors determine that the gesture being performed includes spreading out one or more parts of a body; and
the function performed by the one or more processors includes increasing the size of an object being displayed as part of the electronic program guide on the display surface and displaying additional information within the object after increasing the size.

14. The apparatus of claim 10, wherein:
the one or more processors cause a video to be displayed as part of the electronic program guide; and
the function performed by the one or more processors includes controlling the video.

15. The apparatus of claim 10, wherein:
the one or more processors determine that the gesture being performed includes sliding a body part on the surface from an icon for a program to a collection area; and
the function performed by the one or more processors includes inserting an entry into a data structure for the collection area, the entry includes an identification of the program, the one or more processors receive a request to access information associated with the collection area and access the data structure for the collection area and display information about programs identified in the data structure for the collection area.

16. The apparatus of claim 10, wherein:
the sensor includes an infra red sensor.

17. The apparatus of claim 10, wherein:
object us a hand interacting with the display surface;
the display surface is flat; and
the sensor is an image sensor.

18. An apparatus for managing content, comprising:
one or more processors;
one or more storage devices in communication with the one or more processors;
a display surface in communication with the one or more processors, the one or more processors cause an image associated with a content item to be displayed on the display surface; and
a sensor in communication with the one or more processors, the sensor senses data indicating moving of an object adjacent to the display surface in the general direction from a position of the image on the display surface toward a content presentation system, the data is communicated from the sensor to the one or more processors, in response to the data the one or more processors send a message to the content presentation system to play the content item.

19. The apparatus of claim 18, wherein:
the sensor senses additional data indicating multiple additional gestures;
the one or more processors identify the multiple additional gestures and perform functions associated with the multiple additional gestures.

20. The apparatus of claim 19, wherein:
the content item is a video presentation;
the one or more processors are in communication with a network;
the content presentation system includes a television connected to a set top box and a digital video recorder, the set top box is in communication with the network; and
the message requests that the set top box tune the video presentation and the digital video recorder pause the video presentation.
